(19) United States
(12) Patent Application Publication
(10) Pub. No.: US 2019/0100177 A1
(43) Pub. Date: Apr. 4, 2019

(54) METHOD FOR CHANGING A FORWARD DISPLACEMENT OF AN OCCUPANT OF A VEHICLE DURING BRAKING OF THE VEHICLE AND CONTROL UNIT

(71) Applicant: Robert Bosch GmbH, Stuttgart (DE)

(72) Inventors: Andreas Schulz, Loewenstein-Hoesslinsuelz (DE); Armin Koehler, Sachsenheim (DE); Heiko Freienstein, Weil Der Stadt (DE)

(21) Appl. No.: 16/086,412

(22) PCT Filed: Mar. 29, 2017
(86) PCT No.: PCT/EP2017/057361

§ 371 Date: Sep. 19, 2018

(30) Foreign Application Priority Data
Apr. 7, 2016 (DE) 10 2016 205 800.2

(51) Int. Cl. B60T 8/1755; B60R 21/015

(52) U.S. Cl. CPC B60T 8/17555; B60R 2021/0102; B60R 21/01544; B60R 21/01542

(57) ABSTRACT

The invention relates to a method for changing a forward displacement (104) of an occupant (106) of a vehicle (100) during braking of the vehicle (100). Initially, a seat belt status signal (112) which represents a status of a seat belt (108) for buckling in the occupant (106), and an occupant position signal which represents a position and/or location of the occupant (106) in the vehicle (100) and/or a change in the position and/or the location are read in. The two signals are processed to ascertain the forward displacement (104). Finally, at least one control signal (120, 121, 138) for controlling a braking device (122) of the vehicle (100) and/or at least one restraint means (108, 132) for restraining the occupant (106) is/are generated as a function of the forward displacement (104) in order to alter the forward displacement (104).

### FIELD OF THE INVENTION

The present invention is directed to a device and to a method. The present invention also relates to a computer program.

### BACKGROUND INFORMATION

In previous methods for collision prevention, a braking deceleration may be determined, for example, taking a vehicle speed and pieces of information of a surroundings detection, such as the distance and relative speed, into consideration. It is possible to activate individual occupant protection means based on the ascertained braking deceleration.

### SUMMARY

Against this background, the approach described here introduces a method for changing a forward displacement of an occupant of a vehicle during braking of the vehicle, furthermore a control unit which uses this method, and finally a corresponding computer program.

A method for altering a forward displacement of an occupant of a vehicle during braking of the vehicle is introduced, the method including the following steps:

reading in a seat belt status signal which represents a status of a seat belt for buckling in the occupant, and an occupant position signal which represents a position and/or location of the occupant in the vehicle and/or a change in the position and/or the location;
processing the seat belt status signal and the occupant position signal to ascertain the forward displacement in the driving direction of the vehicle; and
generating at least one control signal for controlling a braking device of the vehicle and/or at least one restraint means for restraining the occupant as a function of the forward displacement in order to alter the forward displacement.

A forward displacement may be understood to mean an inertia-induced forward leaning of the occupant in the driving direction of the vehicle during braking of the vehicle. The occupant may be a driver or a front-seat passenger of the vehicle. The seat belt may be a lap belt, a diagonal torso belt, a three-point seat belt or a belt harness. The status of the seat belt may be characterized, for example, by a resilience of the seat belt or a state of a buckle, of a seat belt retractor or of a seat belt tensioner of the seat belt. The occupant position signal may, for example, be a signal which was generated using a camera for detecting a passenger compartment of the vehicle or a weight sensor integrated into a seat of the occupant. A restraint means may be understood to mean, for example, an electric or pyrotechnic seat belt tensioner for tensioning the seat belt, an air bag or a seat adjustment device for adjusting the seat.

The approach described here is based on the finding that a braking device or a restraint means of a vehicle may be controlled as a function of an individual seat belt status and a position or location of a vehicle occupant in such a way that the forward displacement of the vehicle occupant during deceleration of the vehicle is reduced to a minimum.

By using the seat belt status and a displacement or movement of the occupant dependent thereon for the ascertainment of a necessary braking deceleration of the vehicle, it is also possible to increase the safety of the occupant during an impending collision of the vehicle.

In a corresponding method for ascertaining a braking deceleration curve, it is possible, for example in addition to taking into consideration the individual seat belt status, which indicates, for example, whether the seat belt is fastened or a retractor of the seat belt is blocked, or represents a present resilience or a resilience already applied in the instantaneous fastening cycle, to use a present seat setting, such as a backrest inclination, a seat longitudinal adjustment or a seat cushion inclination or pieces of information of a surroundings detection, such as a distance or a relative speed of the vehicle in relation to a relevant obstacle. In this way, a very precise and reliable determination of a braking profile may be ensured, through the use of which during an impending collision the displacement of the occupant, and thus the consequences of an accident for the occupant, may be minimized.

According to one specific embodiment, it is possible, in the step of processing, to determine a distance of the occupant from a steering wheel, a dashboard and, additionally or alternatively, a backrest of the vehicle representing the forward displacement, using the seat belt status signal and, additionally or alternatively, the occupant position signal. In the step of generating, the control signal may be generated as a function of the distance. In this way, the forward displacement may be determined reliably and precisely with comparatively low complexity.

According to one further specific embodiment, it is possible, in the step of reading in, to read in a signal which represents a resilience of the seat belt as the seat belt status signal. In addition or as an alternative, the seat belt status signal may represent a state of a buckle, of a seat belt retractor or of a seat belt tensioner of the seat belt. This specific embodiment enables a very precise determination of the seat belt status.

It is advantageous when, in the step of reading in, a signal generated by a passenger compartment detection device for detecting a passenger compartment of the vehicle and, additionally or alternatively, of a seat occupancy identification device for identifying a seat occupancy in the vehicle is read in as the occupant position signal. A passenger compartment detection device may be understood to mean, for example, a camera for monitoring the passenger compartment. The seat occupancy identification device may be a weight sensor installed in the seat, for example. In this way, a reliable and precise ascertainment of the forward displacement is made possible.

Furthermore, in the step of reading in, a signal which represents an inclination of a backrest and/or of a seat cushion of a seat occupied by the occupant and/or a position of the seat in the longitudinal direction of the vehicle may be read in as the occupant position signal. The forward displacement may be ascertained as a function of a setting of the seat by this specific embodiment.

According to one further specific embodiment, in the step of reading in, a surroundings sensor signal which represents a signal generated by at least one surroundings sensor of the vehicle and, additionally or alternatively, a brake signal which represents a signal generated by the braking device may be read in. In the step of processing, the surroundings sensor signal and the brake signal may be processed to ascertain an impending collision of the vehicle. Accordingly, in the step of generating, the control signal may be generated as a function of a result of the processing of the surroundings sensor signal and of the brake signal. The restraint means or the braking device may thus be controlled as a function of an impending collision of the vehicle.

In the step of reading in, additionally a piece of occupant information which represents a weight, a height, a gender or an age of the occupant may be read in. In the step of generating, the control signal may be generated, using the piece of occupant information. In this way, the forward displacement may be altered, taking the weight, the height, the gender or the age of the occupant into consideration.

It is furthermore advantageous when, in the step of generating, the control signal is generated to restrain the occupant with the aid of the restraint means, utilizing a path covered by the occupant during the forward displacement. In this way, the forward displacement of the occupant may be reduced preferably quickly to a minimum in the event of a collision.

This method may be implemented in software or hardware or in a mixed form made up of software and hardware, for example in a control unit.

The approach described here furthermore creates a control unit which is designed to carry out, activate or implement the steps of one variant of a method described here in corresponding units. The object of the present invention may also be achieved quickly and efficiently by this embodiment variant of the present invention in the form of a control unit.

For this purpose, the control unit may include at least one processing unit for processing signals or data, at least one memory unit for storing signals or data, at least one interface to a sensor or an actuator for reading in sensor signals from the sensor or for outputting control signals to the actuator and/or at least one communication interface for reading in or outputting data which are embedded into a communication protocol. The processing unit may be a signal processor, a microcontroller or the like, for example, it being possible for the memory unit to be a Flash memory, an EPROM or a magnetic memory unit. The communication interface may be designed to read in or output data wirelessly and/or in a wire-bound manner, a communication interface which is able to read in or output wire-bound data being able to read these data in, for example electrically or optically, from a corresponding data transmission line or output these into a corresponding data transmission line.

A control unit may presently be understood to mean an electrical device which processes sensor signals and outputs control and/or data signals as a function thereof. The control unit may include an interface which may be designed as hardware and/or software. In the case of a hardware design, the interfaces may, for example, be part of a so-called system ASIC which includes a wide variety of functions of the control unit. However, it is also possible for the interfaces to be separate integrated circuits, or to be at least partially made up of discrete elements. In the case of a software design, the interfaces may be software modules which are present on a microcontroller, for example, in addition to other software modules.

In one advantageous embodiment, the control unit carries out a control of a driver assistance system of the vehicle. For this purpose, the control unit may access sensor signals, for example, such as surroundings, acceleration or steering angle sensor signals. The activation takes place via actuators, such as brake or steering actuators, or an engine control unit.

In addition, a computer program product or computer program is advantageous, having program code which may be stored on a machine-readable carrier or memory medium such as a semiconductor memory, a hard disk memory or an optical memory, and which is used to carry out, implement and/or activate the steps of the method according to one of the specific embodiments described above, in particular if the program product or program is executed on a computer or a device.

### BRIEF DESCRIPTION OF THE DRAWINGS

FIG. 1 shows a schematic representation of a vehicle including a control unit according to one exemplary embodiment.

FIG. 2 shows a schematic representation of a control unit according to one exemplary embodiment.

FIG. 3 shows a schematic representation of a control unit according to one exemplary embodiment.

FIG. 4 shows a schematic representation of a strategy for activating a braking profile using a control unit according to one exemplary embodiment.

FIG. 5 shows a schematic representation of a time curve of a deceleration, of a belt force and of an occupant displacement during braking of a vehicle with the aid of a control unit according to one exemplary embodiment.

FIG. 6 shows a schematic representation of a time curve of a deceleration, of a belt force and of an occupant displacement during braking of a vehicle with the aid of a control unit according to one exemplary embodiment.

FIG. 7 shows a schematic representation of a time curve of a deceleration, of a belt force and of an occupant displacement during braking of a vehicle with the aid of a control unit according to one exemplary embodiment.

FIG. 8 shows a flow chart of a method according to one exemplary embodiment.

### DETAILED DESCRIPTION

In the following description of favorable exemplary embodiments of the present invention, identical or similar reference numerals are used for similarly acting elements shown in the different figures, and a repeated description of these elements is dispensed with.

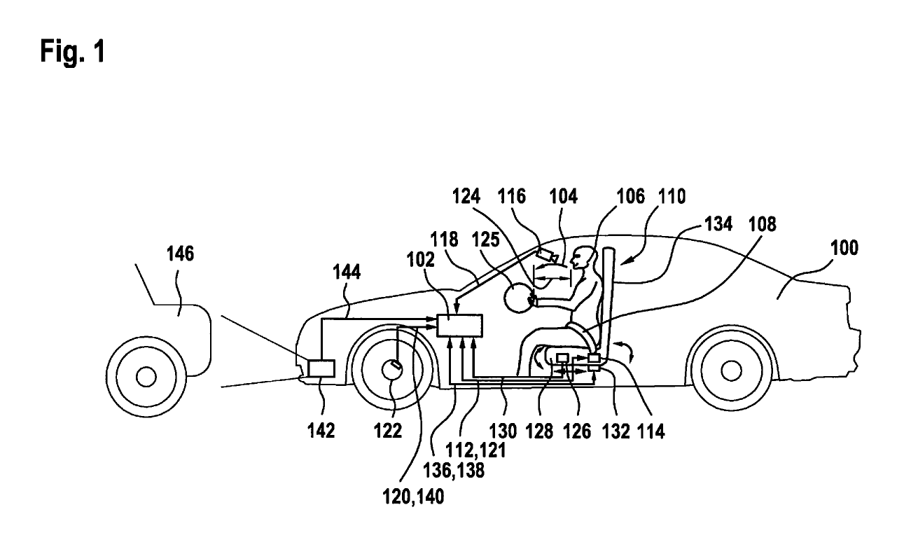

FIG. 1 shows a schematic representation of a vehicle 100 including a control unit 102 according to one exemplary embodiment. Control unit 102 is designed to alter a forward displacement 104 of an occupant 106 of vehicle 100, which here is a driver, during braking of vehicle 100. For this purpose, control unit 102 receives a seat belt status signal 112 which represents a status of seat belt 108 from a seat belt 108, with the aid of which occupant 106 is buckled to a seat 110 of vehicle 100. For example, seat belt status signal 112 according to FIG. 1 indicates that a buckle of seat belt 108 is in a closed state. Seat belt status signal 112 may furthermore represent a resilience of seat belt 108 and a status of a seat belt retractor or of an electric or pyrotechnic seat belt tensioner of seat belt 108. For detecting and transmitting seat belt status signal 112, seat belt 108 according to FIG. 1 includes a seat belt control unit 114. Depending on the exemplary embodiment, seat belt control unit 114 may be designed to control the buckle, the seat belt retractor or the seat belt tensioner, for example to alter the resilience or a slack of seat belt 106. The buckle, the seat belt retractor or the seat belt tensioner may be implemented as part of seat belt control unit 114.

Vehicle 100 furthermore includes a passenger compartment detection device 116, implemented as a camera here, which is designed to detect occupant 106 in the passenger compartment of vehicle 100, and to transmit a detection signal 118 representing occupant 106 to control unit 102. Control unit 102 is designed to ascertain a position or location of occupant 106 in vehicle 100, or also a change in the position or location over time, using detection signal 118. Furthermore, control unit 102 is designed to ascertain forward displacement 104, using seat belt status signal 112 and as a function of the position or location of occupant 106.

Depending on a thus ascertained value of forward displacement 104, control unit 102 according to FIG. 1 generates a first control signal 120 and a second control signal 121. First control signal 120 is used to control a braking device 122 of vehicle 100, and second control signal 121 is used to control a restraint means, which is the seat belt tensioner integrated into seat belt 108 here. Braking device 122 is designed to control a brake force for braking vehicle 100, using first control signal 120. For example, braking device 122 controls the brake force in such a way that forward displacement 104 during braking of vehicle 100 is reduced. Analogously, seat belt control unit 114 is designed to control the resilience of seat belt 108 with the aid of the seat belt tensioner, using second control signal 121, in such a way that forward displacement 104 during braking of vehicle 100 is also reduced.

According to the exemplary embodiment shown in FIG. 1, control unit 102 is designed to ascertain a distance 124 between occupant 106 and a steering wheel 125 of vehicle 100 representing forward displacement 104, using detection signal 118. Accordingly, control unit 102 generates control signals 120, 121 as a function of distance 124.

Optionally, vehicle 100 is equipped with a seat occupancy identification device 126, which is a weight sensor integrated into a seat cushion 128 here. Seat occupancy identification device 126 is designed to identify an occupancy of seat 110 by occupant 106 and to transmit an occupancy signal 130 representing the occupancy to control unit 102. Control unit 102 is designed to ascertain the position or location of occupant 106, in addition or as an alternative to the use of detection signal 118, using occupancy signal 130.

According to one further exemplary embodiment, seat 110 is adjustable with the aid of an optional seat adjustment device 132. Seat adjustment device 132 is designed to alter an inclination of a backrest 134 of seat 110 and of seat cushion 128, and a seat position of seat 110 in the longitudinal direction of vehicle 100. Possible adjustment directions of seat 110 are identified by way of example by three arrows. Seat adjustment device 132 is furthermore designed to detect the inclination of backrest 134 and of seat cushion 128 and the seat position, and to transmit an adjustment signal 136 representing the inclination and the seat position to control unit 102. Control unit 102 is designed to ascertain the position or location of occupant 106 using adjustment signal 136.

Optionally, control unit 102 is designed to generate a third control signal 138 as a function of the ascertained forward displacement 104, and to transmit it to seat adjustment device 132. Seat adjustment device 132 is designed to control the inclination of backrest 134 or of seat cushion 128, or the seat position, using third control signal 138. Seat adjustment device 132 thus also functions as a restraint means to alter forward displacement 104 of occupant 106.

According to one further exemplary embodiment, braking device 122 is designed to transmit a brake signal 140, which represents the brake force for example, to control unit 102. Vehicle 100 includes an optional surroundings sensor 142, which is designed to detect surroundings of vehicle 100 and to transmit a surroundings sensor signal 144 representing the surroundings to control unit 102. Control unit 102 is designed to ascertain an impending collision of vehicle 100 with an obstacle 146, which is a further vehicle preceding vehicle 100 here, using brake signal 140 and surroundings sensor signal 144, and to generate control signals 120, 121, 138 as a function of an evaluation of the two signals 140, 144 in this regard.

The vehicle surroundings are monitored, for example, by at least one surroundings detection system with the aid of radar, LIDAR or video. An impending collision with an object in the surroundings may be identified by control unit 102 with the aid of corresponding surroundings data of the surroundings detection system. Control unit 102 may be designed to evaluate an avoidability of the collision by steering or brake interventions.

The position of the occupant is monitored with the aid of a passenger compartment detection system, for example. If the occupant is situated in a critical position, i.e., within the keep-out zone, this is identified by an algorithm in control unit 102, and the information is forwarded. The keep-out zone may be described by a distance of the occupant from the steering wheel, the distance being selected smaller than 10 cm, for example.

A braking deceleration curve of vehicle 100 may additionally be determined using personal information such as weight, height, gender and age, as is described in greater detail hereafter.

If a braking deceleration initiated by the occupant is not sufficient to avoid a collision of the vehicle, optimal braking assistance may be ascertained with the aid of control unit 102.

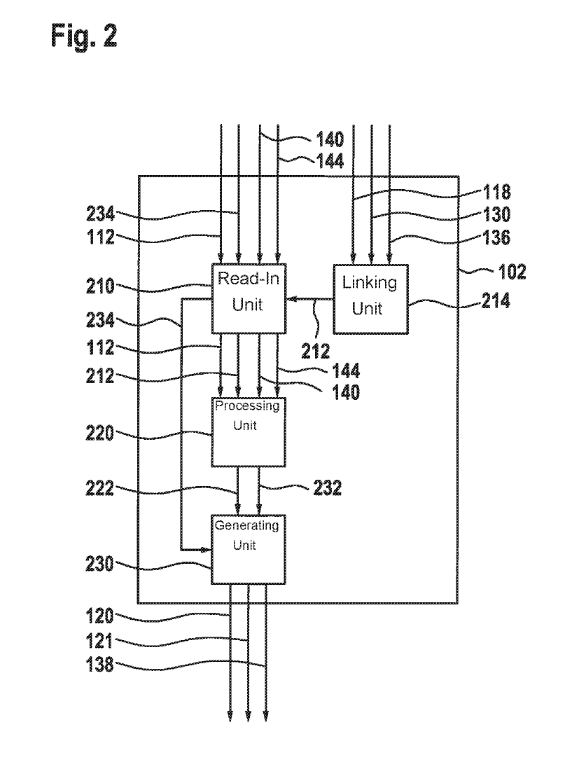

FIG. 2 shows a schematic representation of a control unit 102 according to one exemplary embodiment. Control unit 102 is a control unit described above based on FIG. 1, for example. Control unit 102 includes a read-in unit 210 for reading in seat belt status signal 112 and an occupant position signal 212 which represents the position or location of the occupant or the change in the position or location of the occupant. Occupant position signal 212 is a signal, for example, which was generated based on detection signal 118, occupancy signal 130 or adjustment signal 136 by a linking unit 214 connected to read-in unit 210, and was forwarded to read-in unit 210. Linking unit 214 may be implemented as a component of read-in unit 210.

A processing unit 220 is designed to receive seat belt status signal 112 and occupant position signal 212 from read-in unit 210, to ascertain a forward displacement value 222 representing the forward displacement, using the two signals 112, 212, and to transmit it to a generating unit 230. Generating unit 230 is designed to generate control signals 120, 121, 138, using forward displacement value 222.

According to one optional exemplary embodiment, read-in unit 210 is designed to additionally read in brake signal 140 and surroundings sensor signal 144 and to forward them to processing unit 220. Processing unit 220 is designed to ascertain at least one collision parameter 232 representing the impending collision of the vehicle, for example an impact point in time, an impact location or an impact speed, using the two signals 140, 144, and to transmit it to generating unit 230. Generating unit 230 is designed to furthermore generate control signals 120, 121, 138 taking collision parameter 232 into consideration.

Optionally, read-in unit 210 is designed to read in a piece of occupant information 234, which depending on the exemplary embodiment represents a weight, a height, a gender or an age of the occupant, and to forward it to the generating unit 230. Generating unit 230 is designed to generate control signals 120, 121, 138 using piece of occupant information 234.

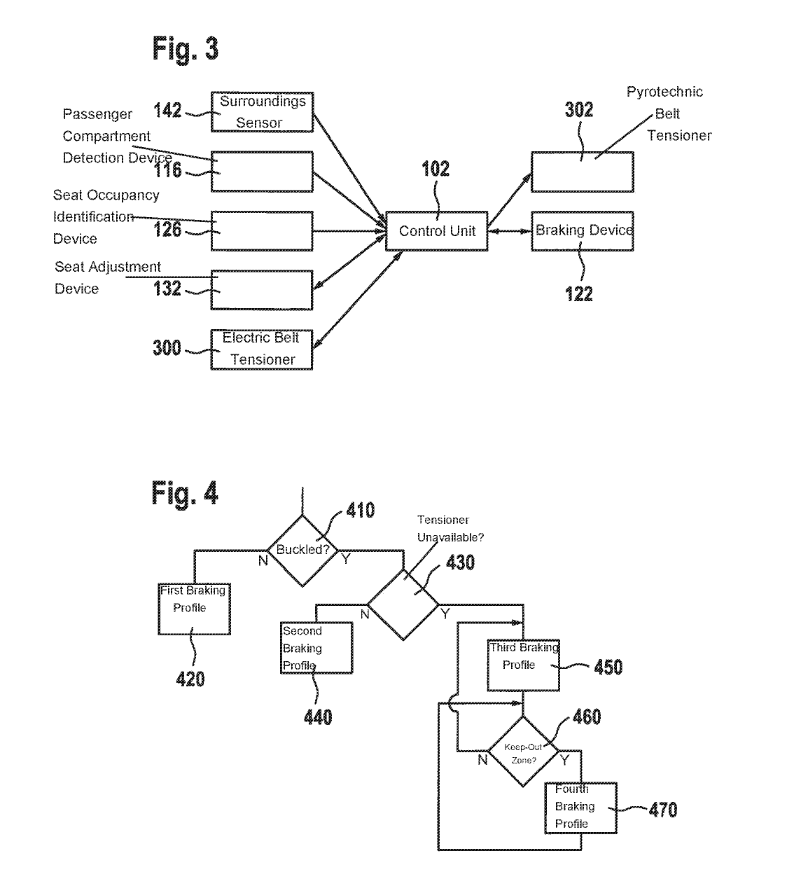

FIG. 3 shows a schematic representation of a control unit 102 according to one exemplary embodiment, for example a control unit as described above based on FIGS. 1 and 2. Control unit 102 is connected to a surroundings detection system, which includes surroundings sensor 142, a passenger compartment detection system, which includes passenger compartment detection device 116, seat occupancy identification device 126, seat adjustment device 132, for example an electric seat adjuster, an electric seat belt tensioner 300 or a pyrotechnic seat belt tensioner 302, which may each form part of the seat belt, and a braking system, which includes braking device 122.

FIG. 4 shows a schematic representation of a strategy for activating a braking profile using a control unit according to one exemplary embodiment, for example a control unit described above based on FIGS. 1 through 3. In a step 410, it is checked whether the occupant is buckled up. If it is established in step 410 that the occupant is not buckled up, a first braking profile for braking the vehicle is activated in a step 420. If, in contrast, it is established in step 410 that the occupant is buckled up, it is checked in a step 430 whether an electric seat belt tensioner is available. If it is established in step 430 that such a seat belt tensioner is not available, a corresponding second braking profile is activated in a step 440. Otherwise, a corresponding third braking profile is activated in a step 450. In response to the activation of the third braking profile, it is checked in a step 460 whether the occupant is situated in the so-called keep-out zone. For example, the occupant is situated in the keep-out zone if the distance between the occupant and the steering wheel drops below a predefined threshold value. If it is established in step 460 that the occupant is situated in the keep-out zone, a corresponding fourth braking profile is activated in a step 470. Otherwise, the third braking profile is activated. In response to the activation of the fourth braking profile, step 460 is repeated at least one more time to enable continuous monitoring of the keep-out zone.

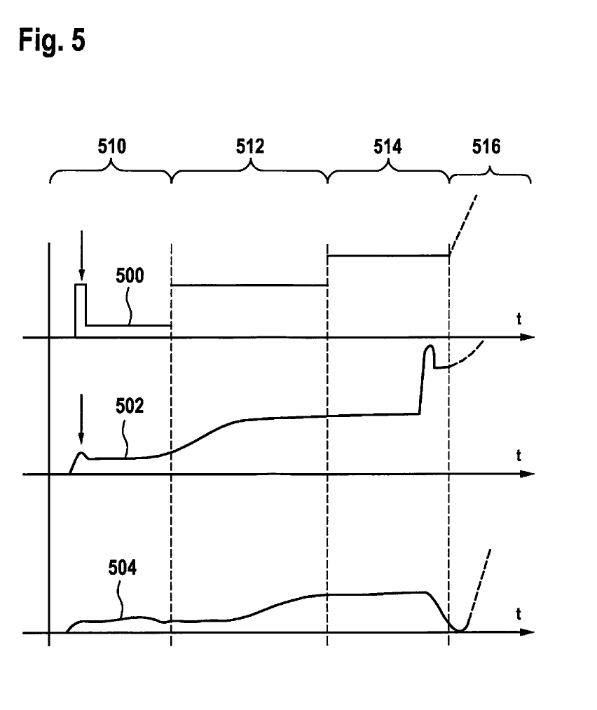

FIG. 5 shows a schematic representation of a time curve of a deceleration 500, of a belt force 502 and of an occupant displacement 504 during braking of a vehicle with the aid of a control unit according to one exemplary embodiment, for example a control unit as described above based on FIGS. 1 through 4. Shown is a braking profile for a buckled-up occupant without electric seat belt tensioner, the individual curves being represented beneath one another. The curves are divided into three chronologically consecutive sections 510, 512, 514, a first section 510 representing an increased criticality, a second section 512 representing a high criticality, and a third section 514 representing an ultrahigh criticality. A fourth section 516 represents a collision of the vehicle.

In first section 510, a non-critical braking jolt takes place, which manifests itself in a steep rise in deceleration 500 and belt force 502 at the beginning of first section 510. Slack of the seat belt may be reduced via the braking jolt. The braking jolt is marked with two arrows in FIG. 5. Subsequent to the braking jolt, a slight deceleration takes place, which maintains the occupant/seat belt coupling, represented by a consistently low deceleration in first section 510.

A partial brake application takes place in second section 512. The deceleration increases suddenly. The belt force shows a slight increase. Toward the end of second section 512, a moderate forward displacement takes place, which is apparent from a slight increase in the occupant displacement.

In third section 514, the deceleration again increases suddenly. The belt force initially remains constant. Toward the end of third section 514, a pyrotechnic seat belt tensioner is pre-triggered, so that the belt force suddenly increases briefly and remains at a significantly higher level than before the seat belt tensioner was ignited. During the ignition of the pyrotechnic seat belt tensioner, the occupant displacement drops steeply, for example to zero, and the occupant experiences a velocity V_{precrash} counter to the crash direction.

The moderate forward displacement in sections 500, 512, 514 preceding the collision may be used by a deploying restraint means to condition the occupant in such a way that a velocity V_{precrash} and a velocity V_{crash} destructively superimpose.

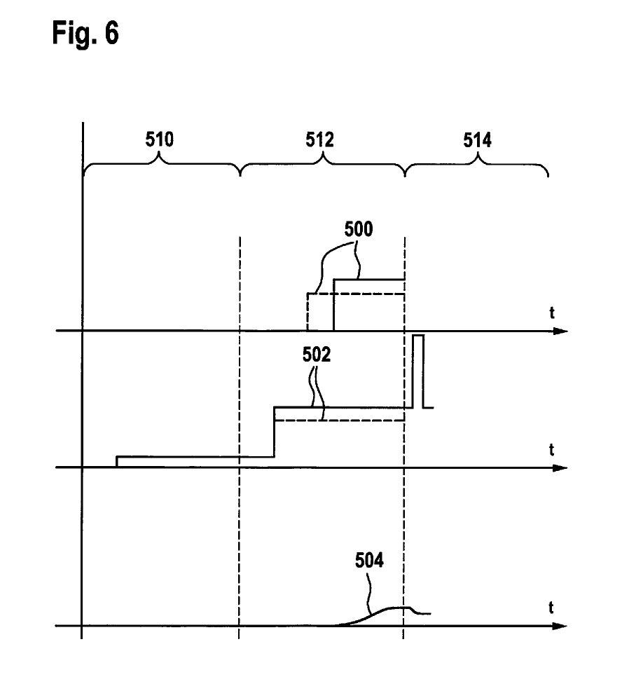

FIG. 6 shows a schematic representation of a time curve of a deceleration 500, of a belt force 502 and of an occupant displacement 504 during braking of a vehicle with the aid of a control unit according to one exemplary embodiment. In contrast to FIG. 5, FIG. 6 shows a braking profile for a buckled-up occupant with an available electric seat belt tensioner. In first section 510, a slight tensioning of the seat belt via the electric seat belt tensioner takes place in order to block it. This results in an earlier coupling. In second section 512, a partial brake application takes place, focusing on collision avoidance or energy reduction. The point in time and magnitude of the deceleration are dependent on the belt force. In third section 514, a full brake application takes place at approximately 1 g. The pyrotechnic seat belt tensioner is pre-triggered to have a deploying system. The space toward the rear may be utilized to build up speed unbraked. After ignition of the pyrotechnic seat belt tensioner, the seat belt tensioner may be by a further device (pyrotechnic, electric, mechanical and/or pneumatic) to obtain a coupling. With the aid of the deploying system, the forward displacement may thus be reduced.

According to a further exemplary embodiment, an active seat adjuster may be used to support a deploying effect.

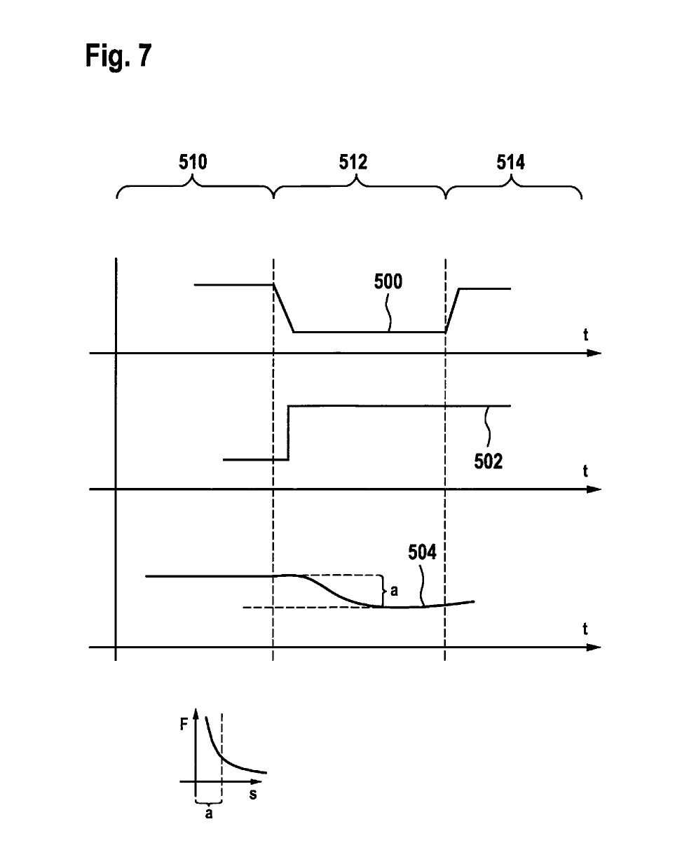

FIG. 7 shows a schematic representation of a time curve of a deceleration 500, of a belt force 502 and of an occupant displacement 504 during braking of a vehicle with the aid of a control unit according to one exemplary embodiment. In contrast to FIGS. 5 and 6, FIG. 7 shows a braking profile for an occupant situated in the keep-out zone, also known as the KO zone.

In second section 512, the occupant is pulled back by lowering the deceleration to reduce the force acting on the occupant and pull him or her out of the KO zone with the aid of the electric seat belt tensioner. The occupant is situated in the KO zone when the distance of the occupant from the steering wheel or from the dashboard is less than 10 cm, for example. The KO zone is shown schematically in FIG. 7 in a separate diagram as distance a between a y axis of the diagram and a dotted line. The y axis represents a force F, and an x axis represents a length s, where

$$\overline{F} = \frac{1}{2} \frac{{mv}^{2}}{s} ,$$

applies.

As soon as it is identified that the occupant is situated in the KO zone, the braking profile is started. As soon as the occupant is situated outside the KO zone, the braking profile is terminated and, for example, a higher-level braking profile is adopted. The advantage of the braking profile shown in FIG. 7 is that the occupant may be moved out of the KO zone by displacement.

Depending on the exemplary embodiment, with the determination of the braking profiles described based on FIGS. 5 through 7 during an impending collision, the displacement of the occupant may be minimized, taking into consideration a present seat belt status (fastened, retractor blocked, present resilience, resilience already applied in the present fastening cycle), a use of the forward displacement as a rearward displacement path by pre-triggering of the pyrotechnic seat belt tensioner, a present seat setting (backrest inclination, seat longitudinal adjustment, seat cushion inclination) and personal information, such as weight, height, gender or age.

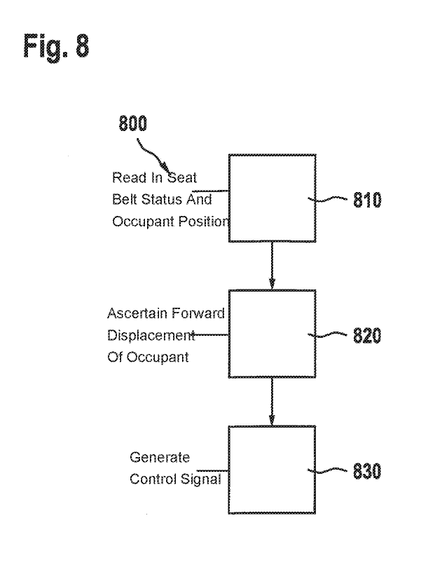

FIG. 8 shows a flow chart of a method 800 according to one exemplary embodiment. Method 800 may be carried out or activated in conjunction with a control unit described above based on FIGS. 1 through 7, for example. In a step 810, the seat belt status signal and the occupant position signal are read in. In a step 820, the two signals are processed to ascertain the forward displacement of the occupant. Finally, in a step 830, the control signal for controlling the braking device or the restraint means of the vehicle is generated as a function of the forward displacement in order to alter the forward displacement.

Steps 810, 820, 830 may be carried out continuously.

For example, method 800 is cyclically invoked during an impending collision of the vehicle, the activation of the electric seat belt tensioner or of the electric seat adjuster being continuously taken into consideration.

Additionally, by igniting the pyrotechnic seat belt tensioner before the collision, a deploying protective system is created, which utilizes the forward displacement of the occupant caused by the vehicle deceleration as a back displacement path.

By creating the back displacement path in the braking profile through the vehicle deceleration and eliminating the slack of the seat belt, the effectiveness of the system may be increased.

If one exemplary embodiment includes an “and/or” linkage between a first feature and a second feature, this should be read in such a way that the exemplary embodiment according to one specific embodiment includes both the first feature and the second feature, and according to an additional specific embodiment includes either only the first feature or only the second feature.

1.-11. (canceled)

12. A method for changing a forward displacement of an occupant of a vehicle during a braking of the vehicle, comprising:
reading in a seat belt status signal that represents a status of a seat belt for buckling in the occupant, and an occupant position signal that represents at least one of:
at least one of a position and a location of the occupant in the vehicle, and
a change in the at least one of the position and the location;
processing the seat belt status signal and the occupant position signal to ascertain the forward displacement; and
generating at least one control signal for controlling at least one of a braking device of the vehicle and at least one restraint device for restraining the occupant as a function of the forward displacement in order to alter the forward displacement.

13. The method as recited in claim 12, wherein:
in the step of processing, a distance of the occupant from at least one of a steering wheel, a dashboard, and a backrest of the vehicle representing the forward displacement is determined on the basis of at least one of the seat belt status signal and the occupant position signal, wherein the control signal is generated as a function of the distance.

14. The method as recited in claim 12, wherein:
in the step of reading in, a signal that represents at least one of a resilience of the seat belt, a state of a buckle, a state of a seat belt retractor, and a state of a seat belt tensioner of the seat belt is read in as the seat belt status signal.

15. The method as recited in claim 12, wherein:
in the step of reading in, a signal is read in as the occupant position signal that is generated by at least one of:
a passenger compartment detection device for detecting a passenger compartment of the vehicle, and
a seat occupancy identification device for identifying a seat occupancy in the vehicle.

16. The method as recited in claim 12, wherein:
in the step of reading in, a signal is read in as the occupant position signal that represents at least one of:
an inclination of at least one of a backrest and a seat cushion of a seat occupied by the occupant, and
a position of the seat in a longitudinal direction of the vehicle.

17. The method as recited in claim 12, wherein:
in the step of reading in, at least one of a surroundings sensor signal that represents a signal generated by at least one surroundings sensor of the vehicle and a brake signal that represents a signal generated by the braking device is read in,
in the step of processing, at least one of the surroundings sensor signal and the brake signal is processed to ascertain an impending collision of the vehicle, and
in the step of generating, the control signal is generated as a function of a result of the processing of at least one of the surroundings sensor signal and the brake signal.

18. The method as recited in claim 12, wherein:
in the step of reading in, a piece of occupant information that represents at least one of a weight, a height, a gender, and an age of the occupant is read in, and
in the step of generating, the control signal is generated based on the piece of occupant information.

19. The method as recited in claim 12, wherein:
in the step of generating, the control signal is generated to restrain the occupant with the aid of the restraint device, utilizing a path covered by the occupant during the forward displacement.

20. A control unit for carrying out a method for changing a forward displacement of an occupant of a vehicle during a braking of the vehicle, the method comprising:
reading in a seat belt status signal that represents a status of a seat belt for buckling in the occupant, and an occupant position signal that represents at least one of:
at least one of a position and a location of the occupant in the vehicle, and
a change in the at least one of the position and the location;
processing the seat belt status signal and the occupant position signal to ascertain the forward displacement; and
generating at least one control signal for controlling at least one of a braking device of the vehicle and at least one restraint device for restraining the occupant as a function of the forward displacement in order to alter the forward displacement.

21. A computer program for carrying out a method for changing a forward displacement of an occupant of a vehicle during a braking of the vehicle, the method comprising:
reading in a seat belt status signal that represents a status of a seat belt for buckling in the occupant, and an occupant position signal that represents at least one of:
at least one of a position and a location of the occupant in the vehicle, and
a change in the at least one of the position and the location;
processing the seat belt status signal and the occupant position signal to ascertain the forward displacement; and
generating at least one control signal for controlling at least one of a braking device of the vehicle and at least one restraint device for restraining the occupant as a function of the forward displacement in order to alter the forward displacement.

22. A machine-readable storage medium on which a computer program is stored, wherein the computer program is for carrying out a method for changing a forward displacement of an occupant of a vehicle during a braking of the vehicle, the method comprising:
reading in a seat belt status signal that represents a status of a seat belt for buckling in the occupant, and an occupant position signal that represents at least one of:
at least one of a position and a location of the occupant in the vehicle, and
a change in the at least one of the position and the location;
processing the seat belt status signal and the occupant position signal to ascertain the forward displacement; and
generating at least one control signal for controlling at least one of a braking device of the vehicle and at least one restraint device for restraining the occupant as a function of the forward displacement in order to alter the forward displacement.
